(19) United States
(12) Patent Application Publication
(10) Pub. No.: US 2021/0341063 A1
(43) Pub. Date: Nov. 4, 2021

(54) CHANNEL SELECTING VALVE

(71) Applicant: SHIN TAI SPURT WATER OF THE GARDEN TOOLS CO., LTD, LU-KANG TOWN (TW)

(72) Inventor: Chin-Yuan Chen, LU-KANG TOWN (TW)

(21) Appl. No.: 16/862,362

(22) Filed: Apr. 29, 2020

(51) Int. Cl. F16K 3/26; F16K 11/20; F16K 11/22

(52) U.S. Cl. CPC F16K 3/26; F16K 11/207; F16K 11/22; F16K 11/202

(57) ABSTRACT

A channel selecting valve has: a main body, two control cores, two stopping members, and two handles. The main body has an intake opening on one side, and a first outlet opening, a second outlet opening, a third outlet opening and a fourth outlet opening on another side. The main body connects the intake opening with each outlet opening. Two openings at each end of the main body respectively accept a control core for assembly. Each control core is a hollow tube with one open end and one closed end, the open end of the control core is inserted into one of the openings of the main body. Each of the closed ends of the control cores is connected to a respective handle for switching. Both of the two control cores have a first through hole, a second through hole, a third through hole and a fourth through hole.

### BACKGROUND OF INVENTION

### Field of Invention

The present invention relates to a channel selecting valve, and more particularly to a channel selecting valve capable of controlling four water channels.

### Description of the Related Art

In order to avoid plants drying up and dying due to lack of water, watering routine is a very frequent and important gardening work. Usually the plants are planted in a wide range or a certain distance from the water source, therefore, the water hose extension is employed and connected to the water via a connector, then the water hose is connected to the sprinkler device. However, it is impossible to achieve the effect of diverting and separately controlling the opening and closing for multiple water hose or sprinkler device. Therefore, when there are many places that need to be watered, it is necessary to find more water sources or to water different places alternatively, which is not convenient in use.

Therefore, it is desirable to provide a channel selecting valve capable to mitigate and/or obviate the aforementioned problems.

### SUMMARY OF THE INVENTION

An objective of present invention is to provide a channel selecting valve, which is capable of improving the above-mention problems.

In order to achieve the above mentioned objective, a channel selecting valve has: a main body, two control cores, two stopping members, and two handles. The main body has an intake opening on one side, and a first outlet opening, a second outlet opening, a third outlet opening and a fourth outlet opening on another side. The main body connects the intake opening with each outlet opening. Two openings at each end of the main body respectively accept a control core for assembly. The main body further has an internal raised portion at a center position for securing the control cores and limiting rotation of the control cores. Each control core is a hollow tube with one open end and one closed end, the open end of the control core is inserted into one of the openings of the main body. An engagement between the stopping member and the opening prevents the control core from detaching. Each of the closed ends of the control cores is connected to a respective handle for switching. Both of the two control cores have a first through hole, a second through hole, a third through hole and a fourth through hole, the first through hole and the second through hole are separated from each other in an axial position but are radially opposed to the third through hole and the fourth through hole, and the third through hole and the fourth through hole are set at a same axial position.

Other objects, advantages, and novel features of invention will become more apparent from the following detailed description when taken in conjunction with the companying drawings.

### BRIEF DESCRIPTION OF DRAWINGS

FIG. 1 is a three-dimensional combination drawing according to a preferred embodiment of the present invention.

FIG. 2 is a three-dimensional exploded view according to the preferred embodiment of the present invention.

FIG. 3 is a combined sectional view of all of outlets being closed according to the preferred embodiment of the present invention.

FIG. 4 shows the alignment of the control cores shown in FIG. 3 according to the preferred embodiment of the present invention.

FIG. 5 is a cross-sectional view of the third outlet opening being opened separately according to the preferred embodiment of the present invention.

FIG. 6 shows the alignment of the control core shown in FIG. 5 of this creation.

FIG. 7 is a cross-sectional view of the fourth outlet opening being opened separately according to the preferred embodiment of the present invention.

FIG. 8 shows the alignment of control core shown in FIG. 7 according to the preferred embodiment of the present invention.

FIG. 9 is a cross-sectional view of the third outlet opening and the fourth outlet opening being simultaneously opened at the same time according to the preferred embodiment of the present invention.

FIG. 10 shows the alignment of the control core shown in FIG. 9 according to the preferred embodiment of the present invention.

FIG. 11 is a sectional view of all outlets being open according to the preferred embodiment of the present invention.

### DETAILED DESCRIPTION OF THE PREFERRED EMBODIMENT

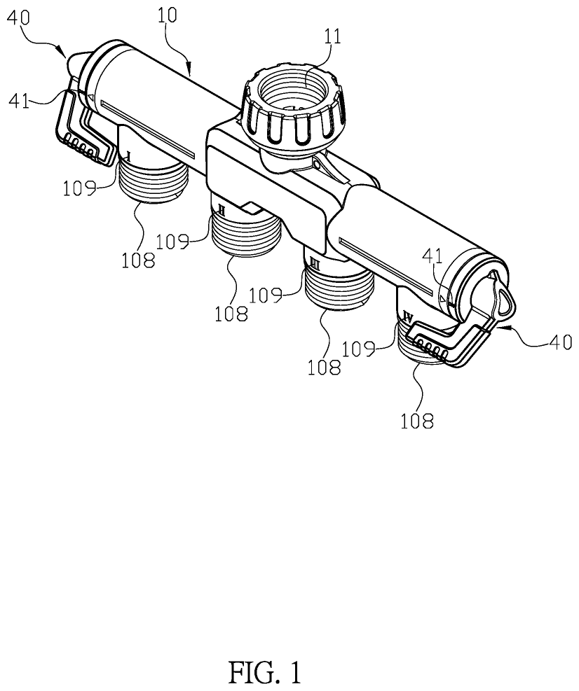

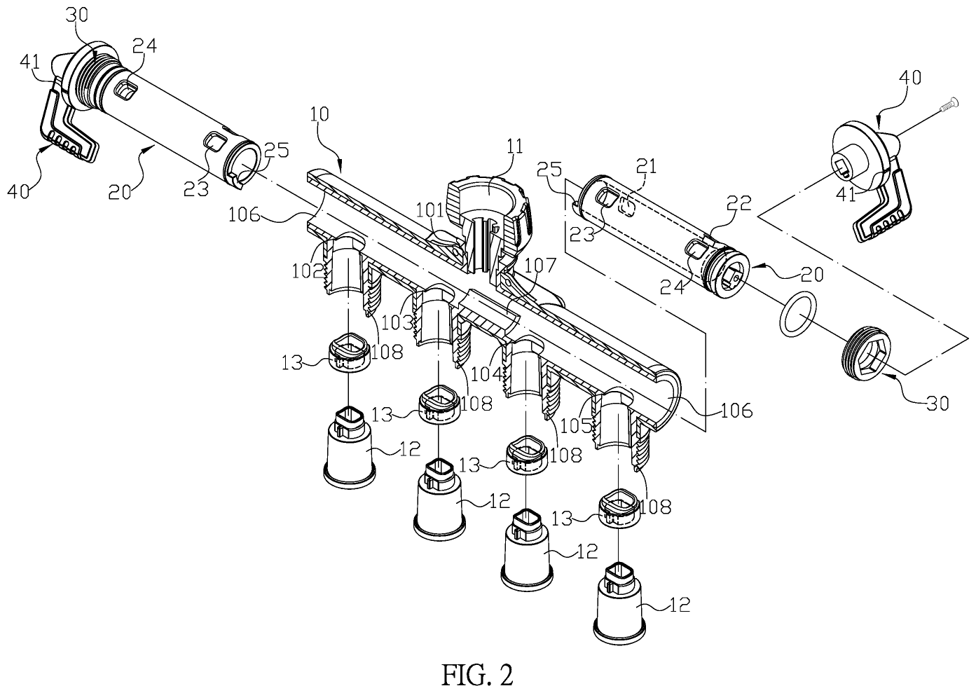

Please refer to FIG. 1 to FIG. 4. A channel selecting valve comprises: a main body 10, a two control core 20, a two stopping member 30 and two handles 40. The main body 10 comprises an intake opening 101 on one side, and a first outlet opening 102, a second outlet opening 103, a third outlet opening 104 and a fourth outlet opening 105 on another side. The main body 10 connects the intake opening 101 with each outlet opening, therefore, water entering from the intake opening 101 can spilt into two directions and enter into each outlet opening. Two openings 106 at each end of the main body 10 respectively accept a control core 20 for assembly. The main body 10 further comprises an internal raised portion 107 at a center position for securing the control cores 20 and limiting rotation of the control cores 20. Each control core 20 is a hollow tube with one open end and one closed end, and the open end of the control core 20 is inserted into one of the openings 106 of the main body 10. An engagement between the stopping member 30 and the opening 106 prevents the control core 20 from detaching. Each of the closed ends of the control cores 20 is connected to a respective handle 40 for independent switching. Both of the two control cores 20 have a first through hole 21, a second through hole 22, a third through hole 23 and a fourth through hole 24, the first through hole 21 and the second through hole 22 are separated from each other in an axial position but are radially opposed to the third through hole 23 and the fourth through hole 24, and the third through hole 23 and the fourth through hole 24 are set at a same axial position. With the first through hole 21, the second through hole 22, the third through hole 23 and the fourth through hole 24, the two handles 40 can be operated together or separately, so the water from the intake opening 101 entering into the main body 10 and the control core 20 can be controlled by the channel selecting valve to achieve one-in/one-out, one-in/two-out, one-in/three-out, one-in/four-out or all closed output options.

Moreover, the channel selecting valve is made of plastic.

Furthermore, wherein the intake opening 101 is connected to a fitting 11 extending from the main body 10.

In addition, the first outlet opening 102, the second outlet opening 103, the third outlet opening 104 and the fourth outlet opening 105 are respectively connected to a connecting pipe 108 extending from the main body 10.

Additionally, each of the connecting pipe 108 respectively has a trumpet-shaped gasket 12 and an inner piston 13.

Moreover, the open end of each control core 20 further has a limiting stopper 25 corresponding to the raised portion 107 of the main body 10, for limiting rotation of the control core 20.

Furthermore, each of the control cores 20 is jacketed with a sealing ring.

In addition, the stopping member 30 is a locking nut configured to be secured onto the opening 106 of the main body 10.

Additionally, there are marks 109 placed on a peripheral of the main body 10 such as I, II, III, IV and corresponding two marks 109 and on/off fidication marks 41 on each of the handles 40 such as I, II, I&II, OFF and III, IV, III&IV, OFF.

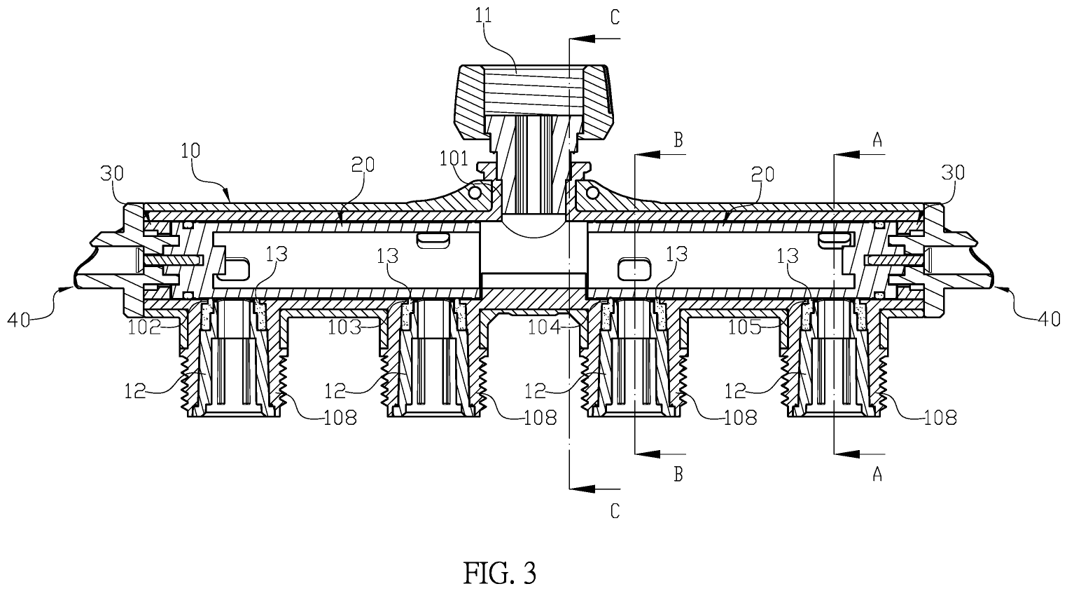

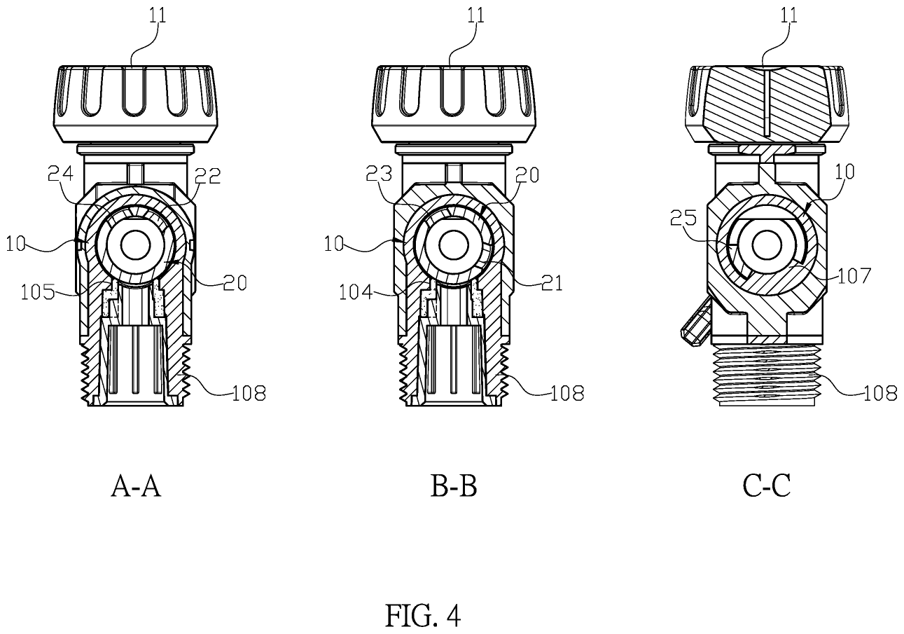

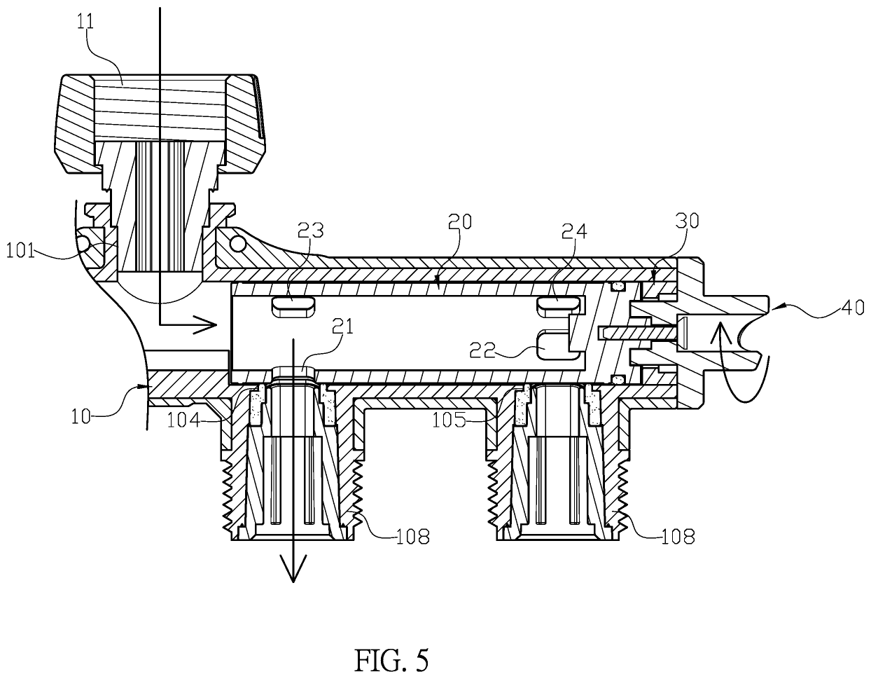

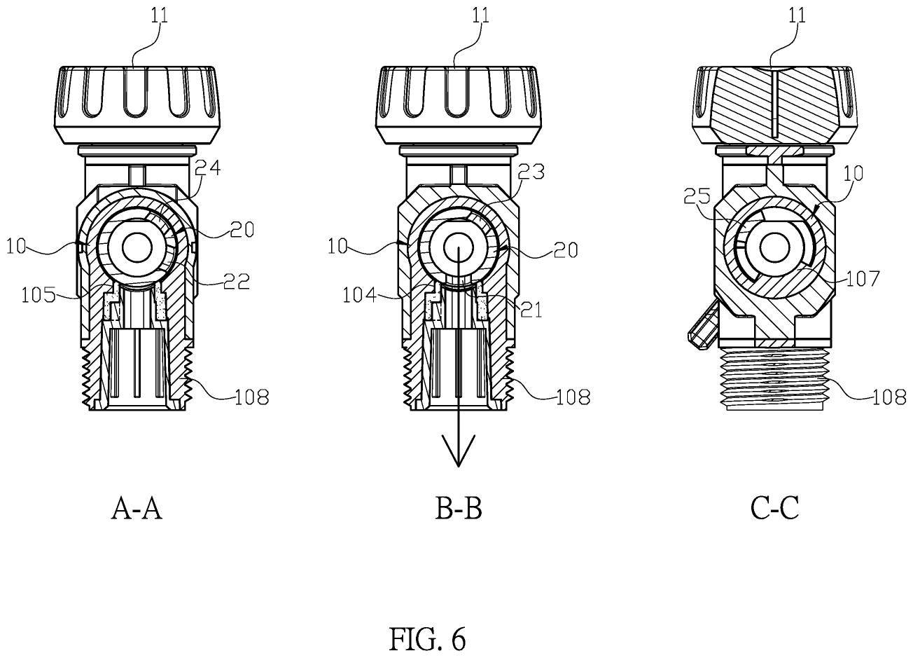

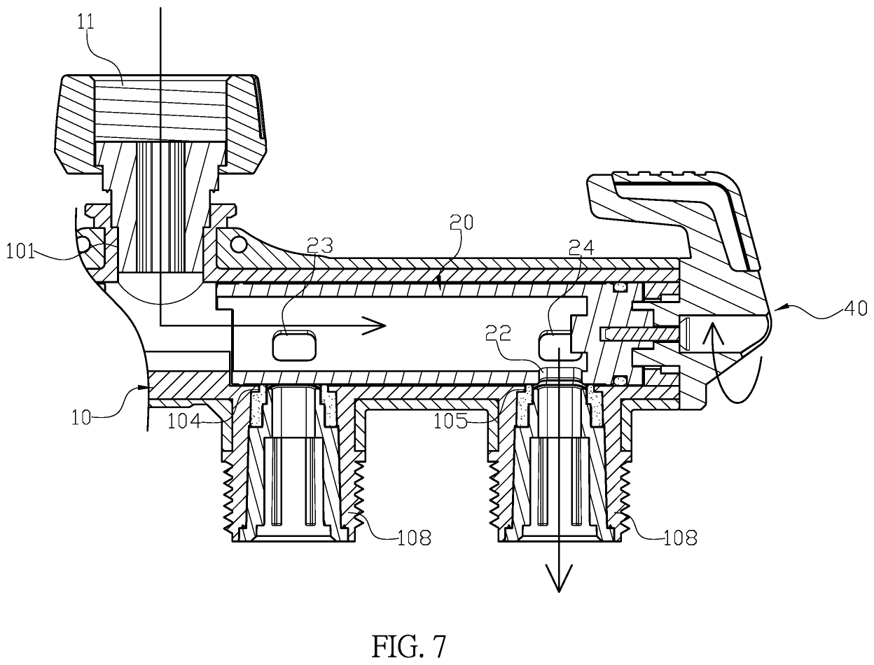

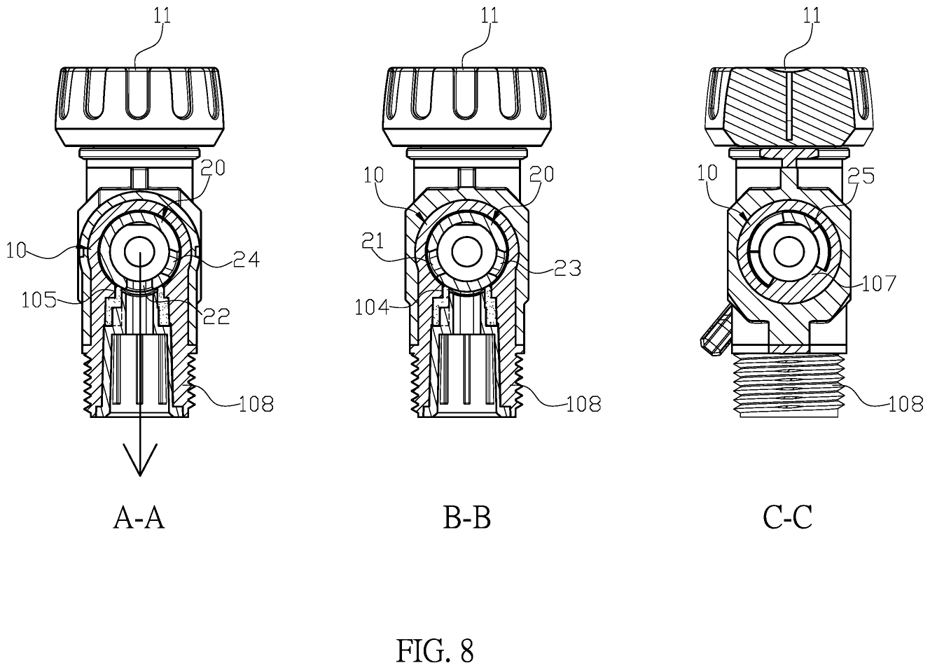

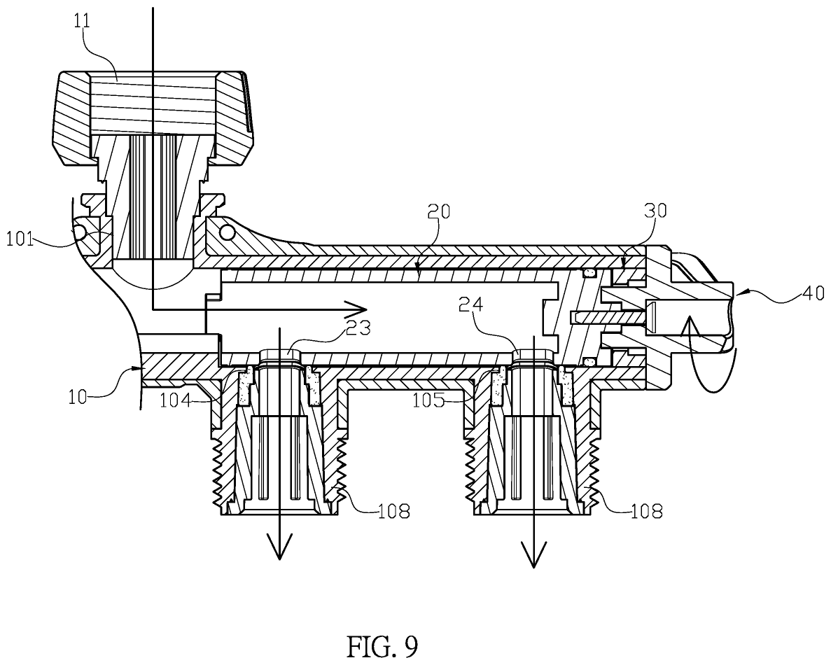

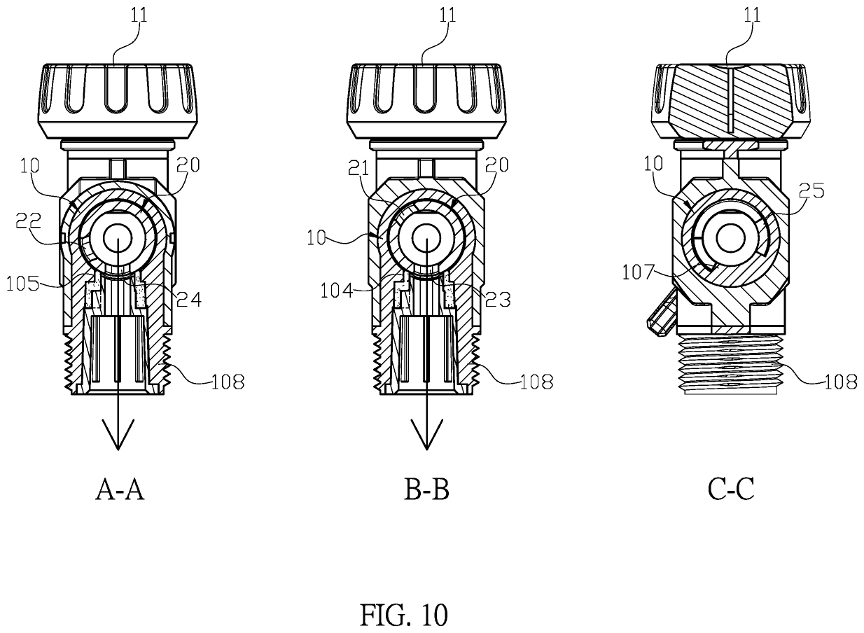

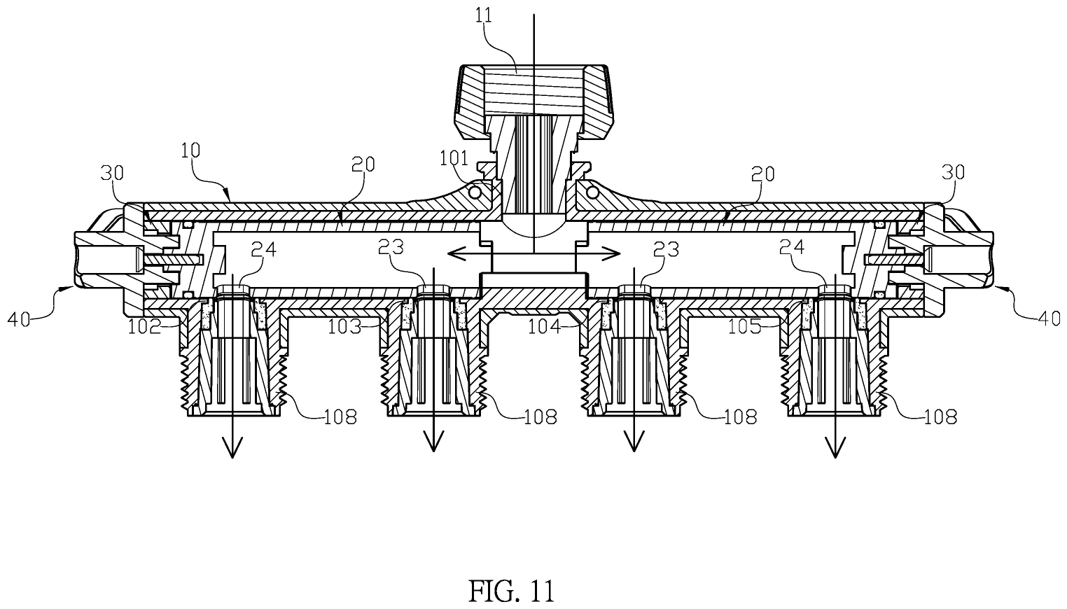

In actual use, the fitting 11 is connected to the water source through the water hose, and each of the connecting pipe 108 is connected to a sprinkler device through the water hose, so that the same water source can be used to provide multiple sprinkling locations for use. Since the channel selecting valve is able to be operated by the handle 40, the two outlets at the same side can be both opened, one opened, one closed or both closed at the same time, depends on appropriate choice for consumers according to actual needs. For example, when the handle 40 adjacent to the third outlet opening 104 and the fourth outlet opening 105 is turned, it simultaneously drive the control core 20 on the same side to produce rotation to align the first through hole 21 on the other side can with the third outlet opening 104 after the first stage of rotation, and the second through hole 22 offsets from the fourth outlet opening 105, so that the water source can only flow out from the third outlet opening 104 (as shown in FIG. 5 and FIG. 6 together). When the handle 40 is turned continuously, the control core 20 produces a second stage of rotation to cause the second through hole 22 to be aligned with the fourth outlet opening 105, and the first through hole 21 offsets the third outlet opening 104, so that the water source can only flow out of the fourth outlet opening 105 alone 9 (as shown in FIGS. 7 and 8). When the third outlet opening 104 and the fourth outlet opening 105 need to be opened simultaneously, the handle 40 is used to drive the control core 20 to rotate to the final third stage, so that the third through hole 23 and the fourth through hole 24 can be aligned with the third outlet opening 104 and the fourth outlet opening 105 at the same time (as shown in FIGS. 9 and 10). When the water need to be turned off, both of the handles 40 are reversely turned back (as shown in FIGS. 3 and 4), which will enable the channel selecting valve to achieve one-in/one-out, one-in/two-out, one-in/three-out, one-in/four-out (as shown in FIG. 11) or all closed output options.

Although the present invention has been explained in relation to its preferred embodiment, it is to be understood that many other possible modifications and variations can be made without departing from the spirit and scope of invention as hereinafter claimed.

What is claimed is:

1. A channel selecting valve comprising: a main body, two control cores, two stopping members, and two handles, wherein:
the main body comprises an intake opening on one side, and a first outlet opening, a second outlet opening, a third outlet opening and a fourth outlet opening on another side, the main body connecting the intake opening with each outlet opening; two openings at each end of the main body respectively accept a control core for assembly; the main body further comprises an internal raised portion at a center position for securing the control cores and limiting rotation of the control cores; and
each control core is a hollow tube with one open end and one closed end, the open end of the control core is inserted into one of the openings of the main body, an engagement between the stopping member and the opening preventing the control core from detaching; each of the closed ends of the control cores is connected to a respective handle for switching; both of the two control cores have a first through hole, a second through hole, a third through hole and a fourth through hole, the first through hole and the second through hole are separated from each other in an axial position but are radially opposed to the third through hole and the fourth through hole, and the third through hole and the fourth through hole are set at a same axial position.

2. The channel selecting valve as claimed in claim 1, wherein the channel selecting valve is made of plastic.

3. The channel selecting valve as claimed in claim 1, wherein the intake opening is connected to a fitting extending from the main body.

4. The channel selecting valve as claimed in claim 1, wherein all of the first outlet opening, the second outlet opening, the third outlet opening, and the fourth outlet opening are respectively connected to a connecting pipe extending from the main body.

5. The channel selecting valve as claimed in claim 4, wherein each of the connecting pipes respectively has a trumpet-shaped gasket and an inner piston.

6. The channel selecting valve as claimed in claim 1, wherein the open end of each control core further has a limiting stopper corresponding to the raised portion of the main body, for limiting rotation of the control core.

7. The channel selecting valve as claimed in claim 1, wherein each of the control cores is jacketed with a sealing ring.

8. The channel selecting valve as claimed in claim 1, wherein the stopping member is a locking nut configured to be secured onto the opening of the main body.
